(19) United States
(12) Patent Application Publication
(10) Pub. No.: US 2019/0168591 A1
(43) Pub. Date: Jun. 6, 2019

(54) PNEUMATIC DOOR SEAL WITH QUICK RELEASE

(71) Applicant: Hyundai Translead, San Diego, CA (US)

(72) Inventors: Calvin Joshua Sykes, San Diego, CA (US); Martin Martinez-Contreras, San Diego, CA (US); Bobby Jung Basnet, San Diego, CA (US)

(21) Appl. No.: 15/829,752

(22) Filed: Dec. 1, 2017

(51) Int. Cl. B60J 10/244; F16J 15/46; F16J 15/02; G05D 7/06; E06B 7/18; B60J 10/84

(52) U.S. Cl. CPC B60J 10/244; F16J 15/46; F16J 15/028; B60J 5/108; E06B 7/18; B60J 10/84; G05D 7/0635

(57) ABSTRACT

Door sealant systems, apparatus, and methods, including: a seal apparatus configured about a door assembly; an air source configured to supply air into the seal apparatus; a plurality of valves including at least a first valve and a second valve, wherein the first valve is coupled to the air source, the first valve configured to inject air into the seal apparatus at a rate slow enough to allow the door assembly to fully close before the seal apparatus expands to push against the door assembly, wherein the second valve is coupled to the seal apparatus, the second valve configured to release air from the seal apparatus at a rate quick enough to allow the door assembly to be opened without damaging the seal apparatus.

### BACKGROUND

### Field of the Invention

The present disclosure relates systems, apparatus and methods for a pneumatic door seal.

### Background

Within the last few years, the conservation of energy and corresponding reduction in air pollution as a result of heavy duty diesel powered trucks and refrigerated trailers has been a major topic. Many jurisdictions currently require reductions in energy use and air pollution by trucks and trailers relating to tractor idling as well as operation of diesel powered refrigeration units when being loaded, unloaded, or in standby mode at warehouses, loading docks, stores, and other general parking areas.

One important area for efficiency gains is the sealing capability of roll-up type doors on refrigerated trailers. By nature of construction, these devices need to have a space or clearance between segments of the door, i.e., door panels, and have relatively low resistance at the perimeter for them to operate properly. These roll-up type doors are less efficient from an energy retention standpoint than swing-type doors. Additionally, forces created by the refrigeration unit push air against the door as it is used as a “bulkhead” to stop air and can create or cause separation between the panels.

### SUMMARY

The present disclosure describes door sealant systems, apparatus, and methods for decreasing the inflation rate and increasing the deflation rate of an elastic membrane of a door assembly.

In one implementation, a door sealant system for x is disclosed. The system includes: a seal apparatus configured about a door assembly; an air source configured to supply air into the seal apparatus; a plurality of valves including at least a first valve and a second valve, wherein the first valve is coupled to the air source, the first valve configured to inject air into the seal apparatus at a rate slow enough to allow the door assembly to fully close before the seal apparatus expands to push against the door assembly, wherein the second valve is coupled to the seal apparatus, the second valve configured to release air from the seal apparatus at a rate quick enough to allow the door assembly to be opened without damaging the seal apparatus.

In another implementation, a method for controlling an air flow rate for a seal apparatus disposed about a door assembly is disclosed. The method includes: first regulating a first rate of a pressurized air being injected into the seal apparatus, wherein the first rate is regulated to be slow enough to allow the door assembly to fully close before the seal apparatus expands to push against the door assembly; and second regulating a second rate of a pressurized air being released from the seal apparatus, wherein the second rate is regulated to be quick enough to allow the door assembly to be opened without damaging the seal apparatus.

In another implementation, an apparatus for controlling an air flow rate for a seal apparatus disposed about a door assembly is disclosed. The apparatus includes: a first regulating means for regulating a first rate of a pressurized air being injected into the seal apparatus, wherein the first rate is regulated to be slow enough to allow the door assembly to fully close before the seal apparatus expands to push against the door assembly; and a second regulating means for regulating a second rate of a pressurized air being released from the seal apparatus, wherein the second rate is regulated to be quick enough to allow the door assembly to be opened without damaging the seal apparatus.

Other features and advantages of the present disclosure should be apparent from the present description which illustrates, by way of example, aspects of the present disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a perspective view of a trailer having wheels, side walls, a roof, a roll-up door assembly that includes at least one door panel, and a door frame;

FIG. 2 is a partial perspective view of a door sealant system including a pneumatic seal apparatus and a roll-up door assembly in accordance with one implementation of the present disclosure;

FIG. 3 is a partial perspective view of a door sealant system including a pneumatic seal apparatus configured as a single-piece design and a roll-up door assembly in accordance with another implementation of the present disclosure;

FIG. 4 is a partial front view of a seal track in accordance with one implementation of the present disclosure;

FIG. 5A is a detailed perspective view of a pneumatic seal apparatus in accordance with one implementation of the present disclosure;

FIG. 5B is a detailed front cutout view of the pneumatic seal apparatus shown in FIG. 5A;

FIG. 6 is a diagram of a door sealant system including a pneumatic seal apparatus and a roll-up door assembly in accordance with one implementation of the present disclosure; and

FIG. 7 is a flow diagram illustrating a method for controlling air flow rate for the door sealant system in accordance with one implementation of the present disclosure.

### DETAILED DESCRIPTION

The disadvantages of above-described door seals can be alleviated to a great extent by providing an elastic membrane that expands when pressurized air is introduced into it for the purposes of creating a seal and/or applying pressure to prevent movement of the door panels. The configuration is such that the deployment of the elastic membrane seal keeps the panels from separating. Thus, in the case of a refrigerated trailer, the configuration improves thermal capacity, and in the case of a dry van, the configuration improves the ability of the door to prevent water ingress at all joints. The seal may be deployed by a manual or electrically-manipulated valve. Further, the elastic membrane can also be automatically deployed using the supply line available on trailers equipped with air brakes. The membrane could be deployed on equipment without supply air available by providing a separate air supply source not intended for braking purposes.

However, some cases, a door sealant system using the above-described expanding elastic membrane may have some disadvantages including inflating too quickly before the door is fully closed and/or deflating too slowly such that the user may raise/open the door before the membrane is fully deflated. Any one or both actions (i.e., (1) deploying the membrane before the door is fully closed, and/or (2) opening the door before the membrane is fully deflated) may damage the membrane and the door.

Therefore, to address the disadvantages of the door sealant system, as described above, certain implementations of the present disclosure provide for decreasing the inflation rate and increasing the deflation rate of the elastic membrane. Accordingly, after reading this description it will become apparent how to implement the present disclosure in various implementations and applications. Although various implementations of the present disclosure will be described herein, it is understood that these implementations are presented by way of example only, and not limitation. As such, this detailed description of various implementations should not be construed to limit the scope or breadth of the present disclosure.

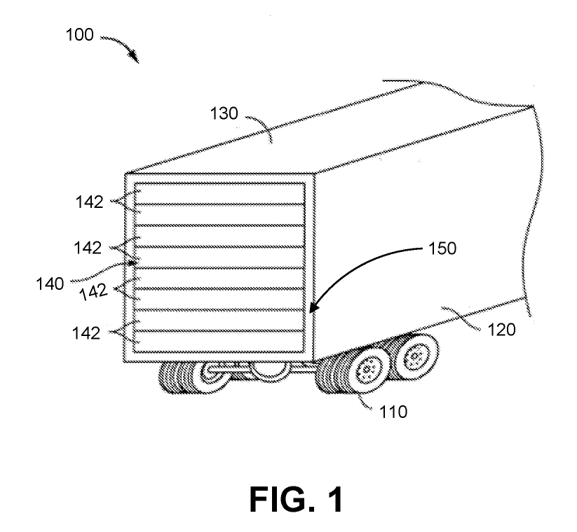

FIG. 1 is a perspective view of a trailer 100 (commonly referred to as a semi-trailer or van) having wheels 110, side walls 120, a roof 130, a roll-up door assembly 140 that includes at least one door panel 142, and a door frame 150. The roll-up door assembly 140 typically has space or clearance between the panels 142, or segments, of the door assembly.

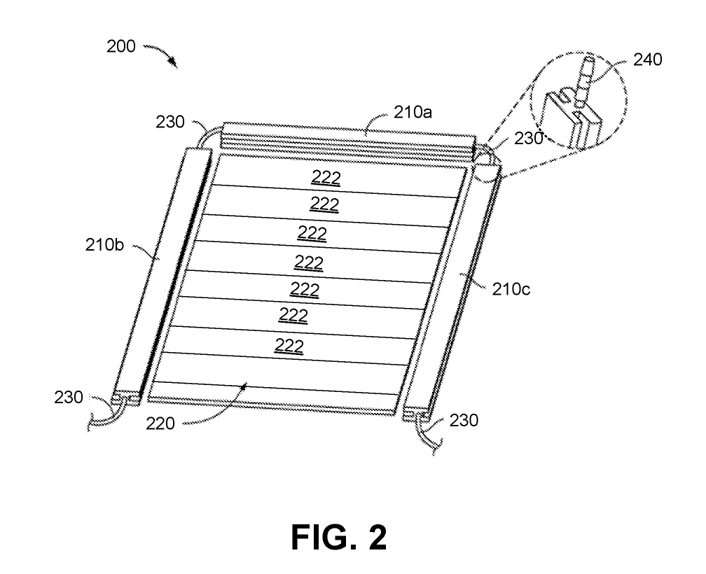

FIG. 2 is a partial perspective view of a door sealant system 200 including a pneumatic seal apparatus 210a, 210b, 210c (collectively referred to as “210”) and a roll-up door assembly 220 in accordance with one implementation of the present disclosure. The pneumatic seal apparatus 210 is arranged around the perimeter of trailer roll doors 220 so as to be adjacent to all door panels 222 and, in some implementations, adjacent the full roll-up door assembly 220. More particularly, the pneumatic seal apparatus 210 is disposed in a seal track 400 (see FIG. 4), which extends around the perimeter of the trailer roll-up door assembly 220 and is sized to receive the pneumatic seal apparatus 210.

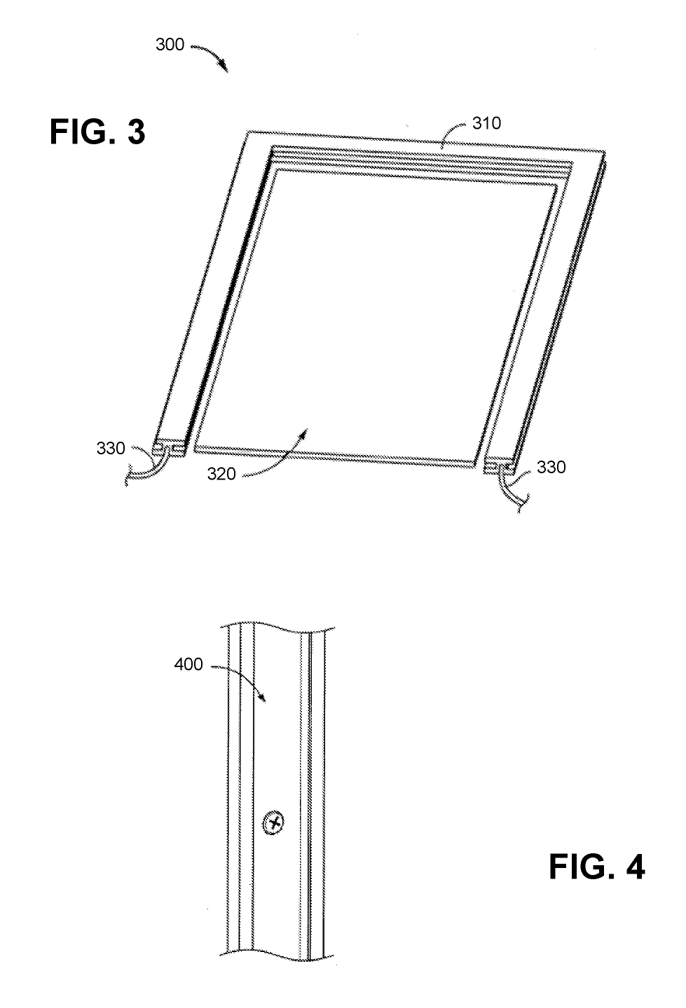

The pneumatic seal apparatus 210 can be configured as a three-piece design (connected by air supply lines 230), as shown in FIG. 2, or as a single-piece design 310 joined together at corners, as shown in FIG. 3. An implementation of a three piece design of pneumatic seal apparatus 210 comprises a header seal 210a and door post seals 210b, 210c. Although the pneumatic seal apparatus 210 of FIG. 2 is divided into three pieces, the pneumatic seal apparatus can be configured with any number of pieces of membranes.

FIG. 2 also includes an inset showing a pneumatic gasket 240 intended to clamp the door panels 222 in place to prevent them from moving. This creates a capture point where gaps between the door panels 222 are substantially reduced and the panels 222 are clamped against the rolling track. In one implementation, the activation is provided by releasing the parking brake supplying air to the trailer and charging the seal through the regulated means such as the pneumatic seal apparatus 210.

FIG. 3 is a partial perspective view of a door sealant system 300 including a pneumatic seal apparatus 310 configured as a single-piece design and a roll-up door assembly 320 in accordance with another implementation of the present disclosure. The illustrated implementation of FIG. 3 also shows air supply lines 330 connected to the pneumatic seal apparatus 310.

FIG. 4 is a partial front view of a seal track 400 in accordance with one implementation of the present disclosure. As stated above, the illustrated implementation of FIG. 4 shows the seal track 400 which extends around the perimeter of the roll-up door assembly 220, 320 and is sized to receive the pneumatic seal apparatus 210, 310.

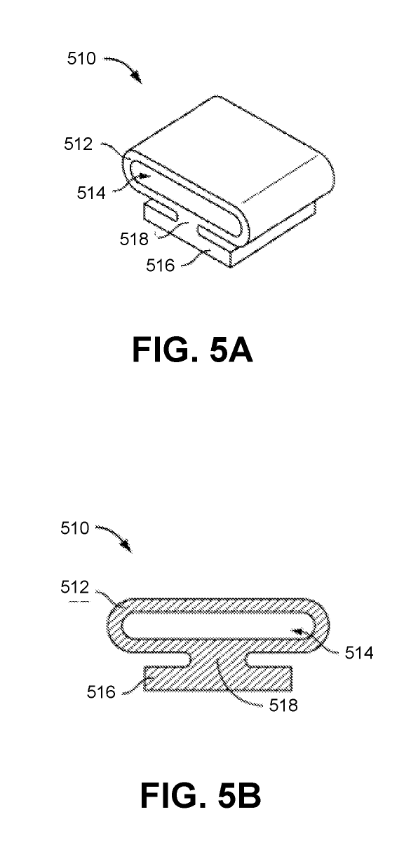

FIG. 5A is a detailed perspective view of a pneumatic seal apparatus 510 in accordance with one implementation of the present disclosure. In the illustrated implementation of FIG. 5A, the pneumatic seal apparatus 510 includes an elastic membrane 512 defining a conduit or tube 514. The elastic membrane 512 expands when the conduit or tube 514 receives pressurized air. In FIG. 5A, the pneumatic seal apparatus 510 also includes a base member 516, which is sized to fit into the seal track 400 shown in FIG. 4. A neck portion 518 may be located between the elastic membrane 512 and the base member 516 and may connect the elastic membrane 512 to the base member 516. It should be noted that a variety of different pneumatic seal arrangements could be used so long as an elastic, expandable material defines a conduit or tube for injection of air.

FIG. 5B is a detailed front cutout view of the pneumatic seal apparatus 510 shown in FIG. 5A.

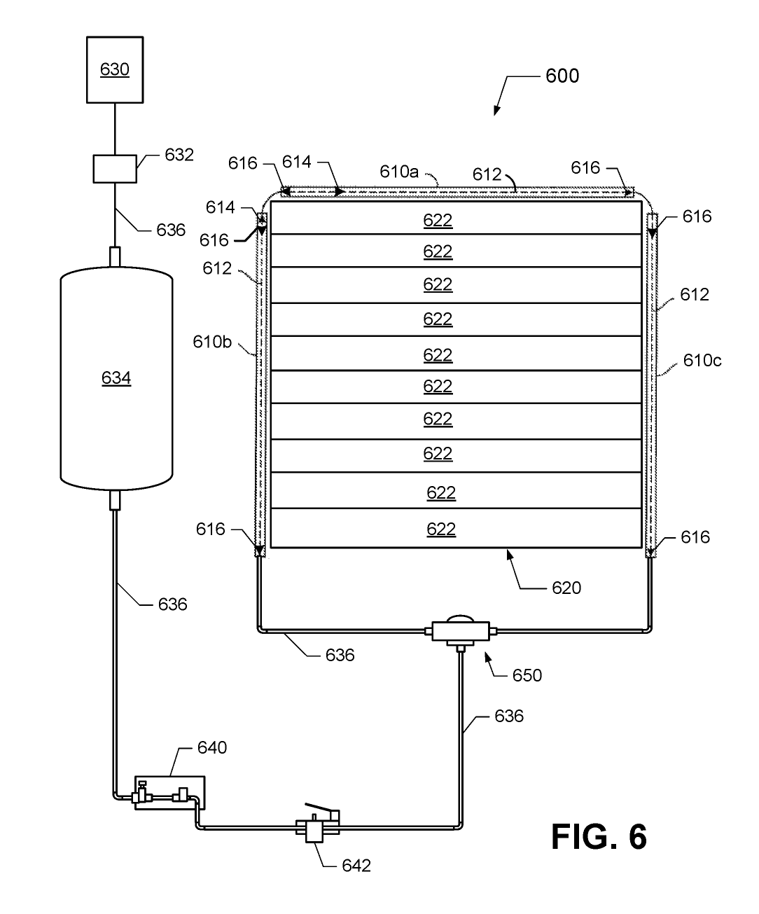

FIG. 6 is a diagram of a door sealant system 600 including a pneumatic seal apparatus 610a, 610b, 610c (collectively referred to as “610”) and a roll-up door assembly 620 in accordance with one implementation of the present disclosure. The door sealant system 600 also includes an air source 630, a parking brake release 632, an air tank 634, an air regulator/activation valve 640, a pneumatic door seal actuator assembly 642, and a quick release valve 650.

In one implementation, the pneumatic seal apparatus 610 of the door sealant system 600 receives air 612 from the air source 630 and the air tank 634 through an air supply line 636. The air supply line 636 may be fluidly connected to the trailer parking brake release 632 such that air 612 from the supply line 636 joins the trailer supply line system at the brake release 632. The supply line 636 is coupled to the air regulator/activation valve 640 and the pneumatic door seal actuator assembly 642. In the illustrated implementation of FIG. 6, the air supply line 636 is also fluidly connected to the pneumatic seal apparatus 610 through the quick release valve 650.

In one implementation, the pneumatic seal apparatus 610 is configured as an elastic membrane of an elongated tube (e.g., 512 in FIGS. 5A and 5B) disposed around a perimeter of the roll-up door assembly 620 so as to be adjacent to the door panels 622. The pressurized air 612 is injected into the pneumatic seal apparatus 610 to expand the elastic membrane of the elongated tube 512 and to apply an outward force against multiple sides of the door panels 622. Applying the distributed outward force against the door panels 622 on multiple sides keeps the door panels 622 as a single unit such that substantially less air flows through the door panels than prior to the application of the outward force to seal the roll-up door assembly 620. That is, the application of the distributed pressure between the door panels 622 and the door frame (e.g., 150 in FIG. 1) creates a supporting structure to the door frame. Further, the application of the distributed pressure between the door panels 622 and the frame 150 reduces or eliminates the resonance from the door when operated over the road, reducing or eliminating stress to the rollers, hardware and hinges holding the roll-up door panels 622 in place.

In the illustrated implementation of FIG. 6, the rate of the pressurized air 612 being injected (see arrows 614) into the pneumatic seal apparatus 610 is regulated by the air regulator/activation valve 640 to be injected at a slower rate (e.g., half) than the air injection rate of a conventional configuration so that the inflation rate of the elastic membrane is correspondingly decreased. This allows the door assembly 620 to be fully closed (i.e., allows the sectional door 620 to be pulled all the way down) before the elastic membrane presses against it. Otherwise, the door panels 622 and or the membrane can be damaged.

The implementation of FIG. 6 further shows air 612 being supplied to the pneumatic seal apparatus 610 from the trailer's air tank 634, which receives air from the external air source 630. A supply line 636 is fluidly connected to the air tank 634 and extends to the air regulator/activation valve 640, which serves to regulate the pressure of air 612. The regulator/activation valve 640 may be configured to allow the air flow at a preset pressure or within a preset range and automatically cut off the flow of air 612 if the pressure is outside the preset range. As described above, in the illustrated implementation of FIG. 6, the rate of the pressurized air 612 being injected into the pneumatic seal apparatus 610 is regulated by the air regulator/activation valve 640 to be injected at a slower rate than the rate for the conventional configuration so that the inflation rate of the membrane is correspondingly decreased.

In the illustrated implementation of FIG. 6, the air regulator/activation valve 640 can be manually operated or automatically controlled electrically (e.g., using an electric solenoid valve or via wireless communication). In one implementation, a refrigeration unit of the trailer can be electrically connected to the solenoid valve (e.g., using the pneumatic door seal actuator assembly 642) to operate the pressurized air 612 being supplied to the membrane thus working in unison with the refrigeration cycles.

In the illustrated implementation of FIG. 6, the rate of the pressurized air 612 being deflated (see arrows 616) from the pneumatic seal apparatus 610 is regulated by the quick release valve 650. Since the air 612 is being released out of both ends by the quick release valve 650, the air 612 is deflated at a faster rate (e.g., double) than the air release rate of a conventional configuration so that the deflation rate of the elastic membrane is correspondingly increased. This allows the elastic membrane to deflate quickly so that the membrane quickly loses contact with the door panels 622 before the sectional door 620 is pulled up. Otherwise, if the membrane is still in contact with the door panels 622 when the sectional door assembly 620 is moved, the door panels 622 and or the membrane can be damaged. The quick release of air is important because many trailers have the door sealant system 600 that is activated or deactivated by the cam latch coupled to the door assembly 620. Further, the quicker rate of deflation of the current implementation is because the current implementation includes the quick release valve 650, whereas the conventional implementations normally use the air regulator/activation valve to both inject air into and release air out of the seal apparatus.

The main feature which differentiates the current implementations (e.g., the implementation shown in FIG. 6) from the existing designs is that by adding the quick release valve (e.g., element 650) as shown, for example, in the illustrated implementation of FIG. 6, the system (e.g., the door sealant system 600) can quickly deflate the elastic membrane(s) as soon as the door latch is open. This allows the door to open immediately (i.e., relatively quickly such that the door can be opened quicker than the door of the existing design) without friction from the seal and without damaging the membrane. Thus, by using a separate valve (e.g., the quick release valve 650) for quickly releasing air from the system (e.g., system 600) separate from an activation valve (the air regulator/activation valve 640), the activation valve can be used to slowly inflate the system and prevent the seal from pressing on the door before it is fully closed and locked in place.

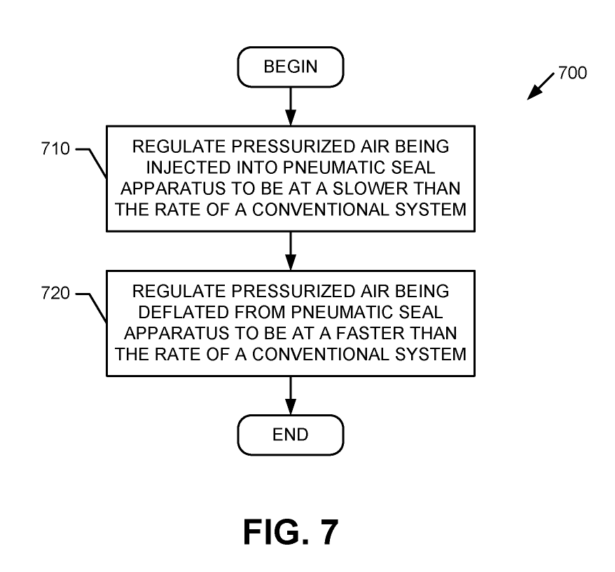

FIG. 7 is a flow diagram illustrating a method 700 for controlling air flow rate for the door sealant system 600 in accordance with one implementation of the present disclosure. In the illustrated implementation of FIG. 7, the rate of the pressurized air 612 being injected into the pneumatic seal apparatus 610 is regulated by the air regulator/activation valve 640, at block 710, to be injected at a slower rate than the air injection rate of a conventional configuration so that the inflation rate of the elastic membrane is correspondingly decreased. This allows the door assembly 620 to be fully closed before the elastic membrane presses against it and prevent the door panels 622 and or the membrane can be damaged. Then, at block 720, the rate of the pressurized air 612 being deflated from the pneumatic seal apparatus 610 is regulated by the quick release valve 650 to be at a faster rate than the air release rate of a conventional configuration so that the deflation rate of the elastic membrane is correspondingly decreased. This allows the elastic membrane to deflate quickly so that the membrane quickly loses contact with the door panels 622 before the sectional door 620 is pulled up and prevent damage to the door panels 622 and or the membrane.

The above description of the disclosed implementations is provided to enable any person skilled in the art to make or use the invention as described in the specification presented above. Various modifications to these implementations will be readily apparent to those skilled in the art, and the generic principles described herein can be applied to other implementations without departing from the spirit or scope of the disclosure. For example, although the above description uses only two valves, one to slowly inject air into the pneumatic seal apparatus and another to quickly release air out of the pneumatic seal apparatus, additional valves can be used to perform other functions. Accordingly, the techniques are not limited to the specific examples described above. Thus, it is to be understood that the description and drawings presented herein represent a presently possible implementation of the disclosure and are therefore representative of the subject matter that is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A door sealant system, comprising:
a seal apparatus configured about a door assembly;
an air source configured to supply air into the seal apparatus;
a plurality of valves including at least a first valve and a second valve,
wherein the first valve is coupled to the air source, the first valve configured to inject air into the seal apparatus at a rate slow enough to allow the door assembly to fully close before the seal apparatus expands to push against the door assembly,
wherein the second valve is coupled to the seal apparatus, the second valve configured to release air from the seal apparatus at a rate quick enough to allow the door assembly to be opened without damaging the seal apparatus.

2. The door sealant system of claim 1, wherein the door assembly is a roll-up door assembly having a plurality of panels.

3. The door sealant system of claim 2, wherein the seal apparatus includes an elastic membrane configured as an elongated tube disposed around a perimeter of the door assembly to apply an outward force against the plurality of panels when the elongated tube is expanded.

4. The door sealant system of claim 1, wherein the first valve is an air regulator/activation valve.

5. The door sealant system of claim 1, wherein the second valve is a quick release valve.

6. The door sealant system of claim 1, wherein the seal apparatus includes two ends, each end disposed at each side of the door assembly.

7. The door sealant system of claim 6, wherein the second valve couples to the two ends of the seal apparatus to allow the air to be released through the two ends.

8. A method for controlling an air flow rate for a seal apparatus disposed about a door assembly, the method comprising:
first regulating a first rate of a pressurized air being injected into the seal apparatus,
wherein the first rate is regulated to be slow enough to allow the door assembly to fully close before the seal apparatus expands to push against the door assembly; and
second regulating a second rate of a pressurized air being released from the seal apparatus,
wherein the second rate is regulated to be quick enough to allow the door assembly to be opened without damaging the seal apparatus.

9. The method of claim 8, wherein the first regulating is performed with an air regulator/activation valve.

10. The method of claim 9, wherein the air regulator/activation valve is automatically and electrically controlled.

11. The method of claim 10, wherein the air regulator/activation valve is automatically and electrically controlled using an electric solenoid valve.

12. The method of claim 10, wherein the air regulator/activation valve is automatically and electrically controlled via wireless communication.

13. The method of claim 8, wherein the second regulating is performed with a quick release valve.

14. The method of claim 13, wherein the second regulating comprises:
coupling two ends of the seal apparatus to the quick release valve; and
releasing the pressurized air from the seal apparatus through the two ends of the seal apparatus.

15. The method of claim 8, wherein the first regulating comprises
injecting the pressurized air into the seal apparatus to expand an elastic membrane of the seal apparatus and to apply an outward force against panels of the door assembly.

16. An apparatus for controlling an air flow rate for a seal apparatus disposed about a door assembly, the apparatus comprising:
a first regulating means for regulating a first rate of a pressurized air being injected into the seal apparatus,
wherein the first rate is regulated to be slow enough to allow the door assembly to fully close before the seal apparatus expands to push against the door assembly; and
a second regulating means for regulating a second rate of a pressurized air being released from the seal apparatus,
wherein the second rate is regulated to be quick enough to allow the door assembly to be opened without damaging the seal apparatus.

17. The apparatus of claim 16, wherein the first regulating means performs the regulation of the pressurized air with an air regulator/activation valve.

18. The apparatus of claim 16, wherein the second regulating means performs the regulation of the pressurized air with a quick release valve.

19. The apparatus of claim 16, wherein the second regulating means couples two ends of the seal apparatus to release the pressurized air from the seal apparatus through the two ends of the seal apparatus.

20. The apparatus of claim 16, further comprising
means for injecting the pressurized air into the seal apparatus to expand an elastic membrane of the seal apparatus and to apply an outward force against panels of the door assembly.
